(19) United States
(12) Patent Application Publication
(10) Pub. No.: US 2025/0117956 A1
(43) Pub. Date: Apr. 10, 2025

(54) THREE-DIMENSIONAL SCANNING OF AN ENVIRONMENT HAVING REFLECTIVE SURFACES

(71) Applicant: Telefonaktiebolaget LM Ericsson (publ), Stockholm (SE)

(72) Inventors: Volodya GRANCHAROV, Solna (SE); Manish SONAL, Sollentuna (SE)

(73) Assignee: Telefonaktiebolaget LM Ericsson (publ), Stockholm (SE)

(21) Appl. No.: 18/729,144

(22) PCT Filed: Jan. 17, 2022
(86) PCT No.: PCT/EP2022/050874

§ 371 Date: Jul. 15, 2024

(51) Int. Cl. G06T 7/55; G06T 7/13; G06T 7/521; G06T 7/73

(52) U.S. Cl. CPC G06T 7/55; G06T 7/13; G06T 7/521; G06T 7/74; G06T 2207/10024; G06T 2207/10028

(57) ABSTRACT

A method (1200) generating a three-dimensional (3D) representation of a real environment is provided. The method (1200) is performed by an apparatus (1300). The method (1200) comprises obtaining (s1202) a first image representing a first portion of the real environment, obtaining (s1204) a second image representing a second portion of the real environment, and identifying (s1206) a contour within the first image. The method also comprises identifying (s1208) a first cluster of key points from an area included within the contour, using at least some of the first cluster of key points, and identifying (s1210) a second cluster of key points included in the obtained second image. The method further comprises obtaining (s1212) first dimension data associated with the first cluster of key points, obtaining (s1214) second dimension data associated with the second cluster of key points, and based on the obtained first and second dimension data, determining (s1216) whether the first image contains a reflective surface area.

### TECHNICAL FIELD

Disclosed are embodiments related to methods and apparatus for generating a three-dimensional (3D) representation of a real environment.

### BACKGROUND

Light Detection And Ranging (LiDAR) sensors included in handheld devices like iPad Pro™ and iPhone 12™ have brought 3D modeling and its applications close to millions of consumers. For example, an iOS™ application called “IKEA Place” allows people to scan their homes and try out different furniture placed in Augmented Reality (AR) environments of their scanned homes before buying the furniture.

Even though different devices and/or software solutions suggest capturing data (e.g., scanning a home environment) in slightly different ways, the goal is typically capturing the entire scene. Data acquisition process for iPad Pro™ with LiDAR sensor(s) and Matterport application is illustrated in FIG. 1.

FIG. 1 illustrates a process of performing a 3D scanning of an indoor environment (a.k.a., scene) 100 using a scanning device 102 (e.g., a handheld device such as iPad Pro™ or iPhone 12™) that includes one or more cameras and one or more LiDAR sensor(s) (not shown in the figure). As shown in FIG. 1, a user 104 holding the scanning device 102 may select a particular location (e.g., a first point 112, a second point 114, or a third point 116) in the environment 100 and rotate the scanning device 102 360 degrees at the selected location, thereby capturing the scene 100 360 degrees at the selected location. After capturing the scene, the user 104 may move to another location and iterate the capturing process.

Today, many industrial applications rely on indoor 3D scanning of various places such as, for example, factories, construction areas, areas where indoor telecom installations are needed, etc. These applications use hardware like Matterport Pro2 (e.g., described in “Matterport.” Available: https://matterport.com/industries/3d-photography) and Leica BLK360™ which can output highly accurate 3D models. The Matterport sensor setup is similar to the set up shown in FIG. 1 except for that the scanning device including the camera(s) and the LiDAR sensor(s) rotates automatically (instead of the user 104 holding the scanning device 102 rotating the scanning device 102 manually). The scanning device 102 is programmed to revolve in a circle and capture RGB-D data (images and depth maps) at an equal interval (e.g., 6 scan directions of 60° sectors to make a full rotation). Like the process illustrated in FIG. 1, after capturing the data, the device is placed at different locations, and the scanning is performed at each of the different locations until the whole environment is captured.

### SUMMARY

Certain challenges exist in the known method of scanning a 3D environment. For example, in case a 3D indoor environment includes reflective surface(s), the known method of scanning the environment fails to reconstruct the 3D environment correctly. More specifically, the known reconstruction algorithms fail to estimate correct depth of the reflective surfaces included in the environment, thereby resulting in generating “ghost” artifacts (i.e., duplicated scene structures) in the reconstructed 3D scene, as illustrated in FIG. 2.

As illustrated in FIG. 2, the problem is that a reflective surface 202 such as a mirror or a glass surface can create a perfect reflection of the world, which makes the reflective surface essentially invisible for the LiDAR sensor(s). In this disclosure, a “reflective surface”, a “mirror,” and a “glass surface” are used interchangeably. Thus, in the perspective of the LiDAR sensor(s), an image 206 of an object (e.g., human 204) reflected from the reflective surface 202 is shown to be behind the mirror plane, and the reflected image 206 of the object 204 is undistinguishable from a real object, thereby causing loss of camera pose and geometry artifacts in the scene.

Over the years researchers have tried different approaches to tackle the problem. These approaches include using extra sensors like ultrasonic range sensors or thermal cameras, or using an AprilTag on the camera sensors. Also recently, neural networks have been deployed to fix the problem of failing to detect reflective surfaces. However, none of these solutions is good enough for commercial use because, for example, none of the solutions is a general solution—i.e., the solutions cannot be deployed generally to different use-cases and the solutions are not cost efficient.

To attempt to address this problem, some commercial scanner manufacturers suggest manually marking the problematic reflective surfaces. For example, some device manufacturers like Leica™ suggests masking reflective surface(s) with markers so that a plane can be established on the surface by the laser scanner. Alternative approach, adopted by Matterport iOS™ application (Capture) is to manually mark the object location in the initial scan. However, these manual interventions are time consuming and/or highly inaccurate.

Accordingly, in one aspect of this disclosure, there is provided a method for generating a three-dimensional (3D) representation of a real environment. The method is performed by an apparatus. The method comprises obtaining a first image representing a first portion of the real environment, obtaining a second image representing a second portion of the real environment, identifying a contour within the first image, and identifying a first cluster of key points from an area included within the contour. The method further comprises using at least some of the first cluster of key points, identifying a second cluster of key points included in the obtained second image, obtaining first dimension data associated with the first cluster of key points, obtaining second dimension data associated with the second cluster of key points, and based on the obtained first and second dimension data, determining whether the first image contains a reflective surface area.

In another aspect, there is provided a computer program comprising instructions which when executed by processing circuitry cause the processing circuitry to perform the method(s) described above.

In another aspect, there is provided a carrier containing the computer program described above, wherein the carrier is one of an electronic signal, an optical signal, a radio signal, and a computer readable storage medium.

In another aspect, there is provided an apparatus for generating a three-dimensional (3D) representation of a real environment. The apparatus comprises a memory and processing circuitry coupled to the memory. The apparatus is configured to obtain a first image representing a first portion of the real environment, obtain a second image representing a second portion of the real environment, identify a contour within the first image, and identify a first cluster of key points from an area included within the contour. The apparatus is further configured to, using at least some of the first cluster of key points, identify a second cluster of key points included in the obtained second image, obtain first dimension data associated with the first cluster of key points, obtain second dimension data associated with the second cluster of key points, and based on the obtained first and second dimension data, determine whether the first image contains a reflective surface area.

Embodiments of this disclosure allow automatic detection and removal of reflective surfaces in a visual scene, thereby removing a need for any manual masking/marking and/or any expensive sensor setup. The embodiments work well with images and depth maps as captured by the scanning device. Also because the embodiments do not rely on a machine learning (ML) model that is trained only for a particular visual environment, they can be generally implemented in various embodiments.

The accompanying drawings, which are incorporated herein and form part of the specification, illustrate various embodiments.

### BRIEF DESCRIPTION OF THE DRAWINGS

FIG. 1 shows an exemplary 3D indoor scanning process.

FIG. 2 shows an artifact in a 3D scanned image of an indoor environment.

FIG. 3 shows a process according to some embodiments.

FIG. 4 shows an exemplary configuration for performing a 3D scanning.

FIG. 5 shows contours included in a captured image.

FIG. 6A shows various distances related to an image capturing device, a reflected object image, and an actual object.

FIG. 6B shows how to calculate a distance between a contour and an image capturing device.

FIG. 7A shows an RGB image.

FIG. 7B shows a depth image.

FIG. 8A shows key points extracted from a contour.

FIG. 8B shows matching points matched to key points.

FIG. 9 shows a configuration according to one embodiment.

FIG. 10A shows a configuration for capturing an object.

FIGS. 10B and 10C show captured images.

FIG. 11 illustrates how the size of an area confining points is determined.

FIG. 12 shows a process according to some embodiments.

FIG. 13 is a block diagram of an entity that is capable of performing the methods according to the embodiments of this disclosure.

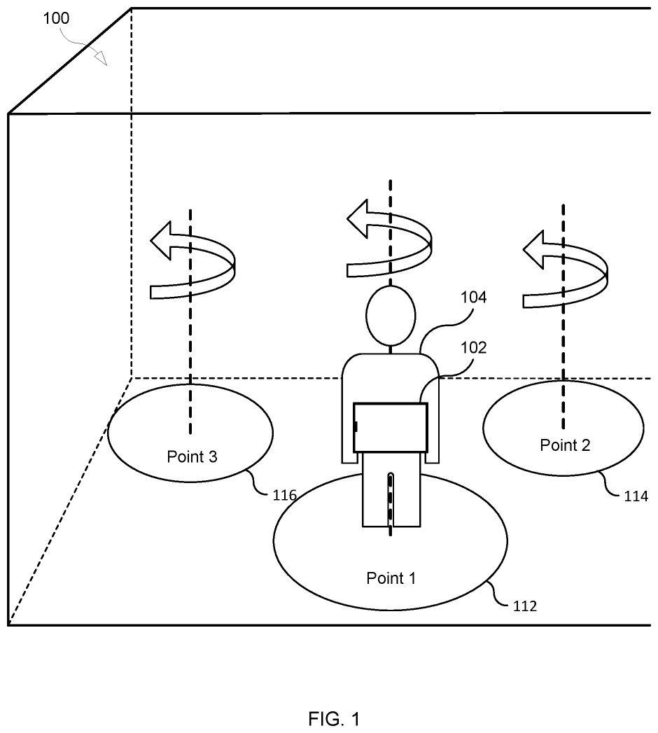

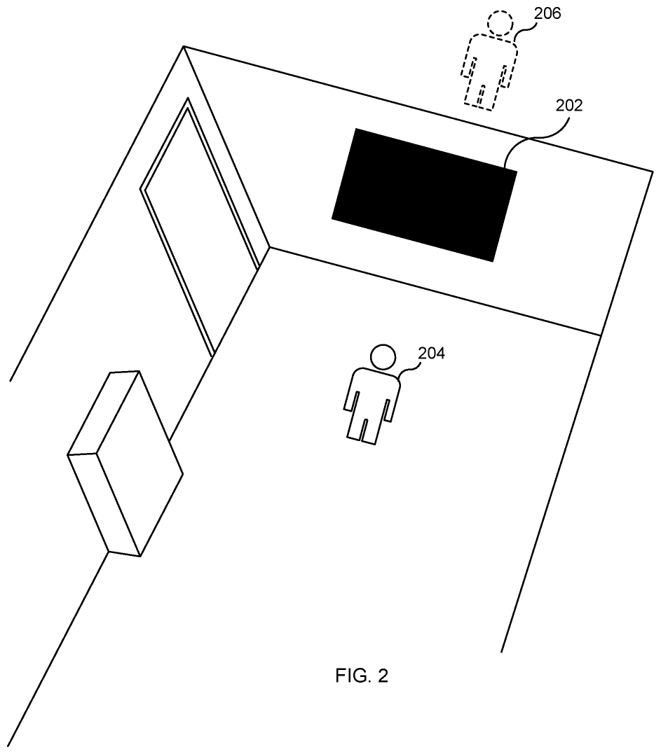

### DETAILED DESCRIPTION

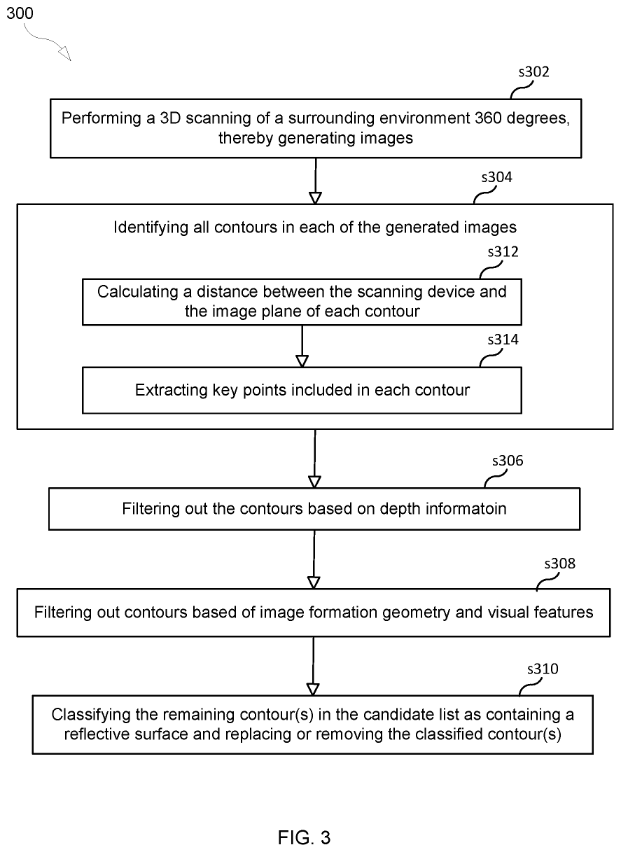

FIG. 3 shows a process 300 for identifying one or more reflective surfaces (a mirror or a glass surface) in a 3D representation of an environment and removing the identified reflective surface(s) from the 3D representation, according to some embodiments. The process 300 may begin with step s302.

Step s302 comprises performing a 3D scanning of a surrounding environment 360 degrees, thereby generating image(s) (e.g., RGB-D images). A RGB-D image is a combination of RGB image channels and a depth image channel. Each pixel in a depth image channel indicates a distance between a scanning device and a corresponding object in the RGB image. In this disclosure, a “scanning device” refers to any device that includes one or more cameras and/or one or more LiDAR sensors.

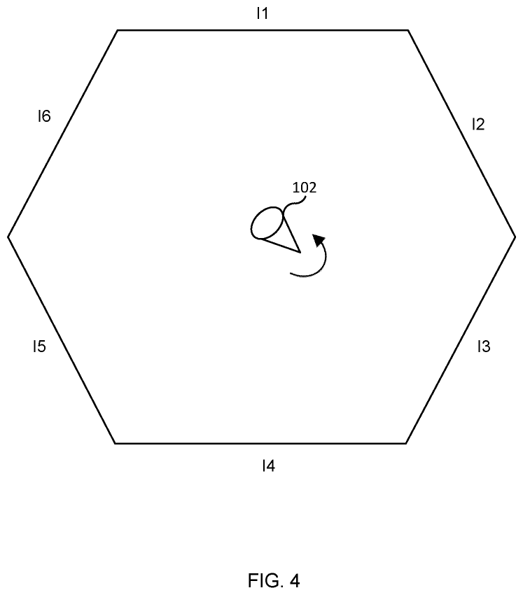

FIG. 4 shows an exemplary configuration for performing the 3D scanning according to some embodiments. As shown in FIG. 4, a scanning device 102 (e.g., a LiDAR sensor) is placed in the center position of an environment. As the scanning 102 rotates, it performs the 3D scanning of the environment 360 degrees, thereby generating six RGB-D images I₁-I₆. Each of the generated RGB-D images can be expressed as:

$${I}_{k} := {( {RGB}_{k} , {D}_{k} )}_{k = 1 , … , 6}$$

The scanning device 102 may be rotated automatically by a motor or manually by a user, and may be included in a stationary device or in a handheld device such as a mobile phone or a tablet.

The number of the collected RGB-D images is not limited to six but can be any number depending on, for example, the configuration and/or the number of the sensor(s) used for capturing the images. For example, a single image showing 360° view of the environment may be generated using a 360° camera like Ricoh Theta Z1™.

The location and/or the number of the scanning device 102 are provided in FIG. 4 for simple explanation and they do not limit the embodiments of this disclosure in any way.

Referring back to FIG. 3, after executing the step s302, step s304 is executed. The step s304 comprises identifying all contours included in each of the generated RGB-D images. In this disclosure, a contour is defined as a curve joining continuous points (e.g., pixels) having substantially the same color or intensity. In this disclosure, a “point” may refer to a pixel or a group of pixels. In case a contour bounds the shape of an object in an image, the contour is called as an object boundary. The contour may be a closed contour or an open contour. The closed contour is a contour that forms a closed loop.

Contour detection is a standard computer vision operation and there is a large number of tools (e.g., findContours( ) in OpenCV) available for performing the contour detection.

For each image Iₖ, closed contours (CLₖ) included in the image are identified and a list of the closed contours (CLₖ) for each image Iₖ is generated: CLₖ=[Cₖ₁, Cₖ₂, . . . . C_{kM}], where k is the number of the generated images (e.g., in FIG. 4, k=6) and M is the number of closed contours identified in each image Iₖ.

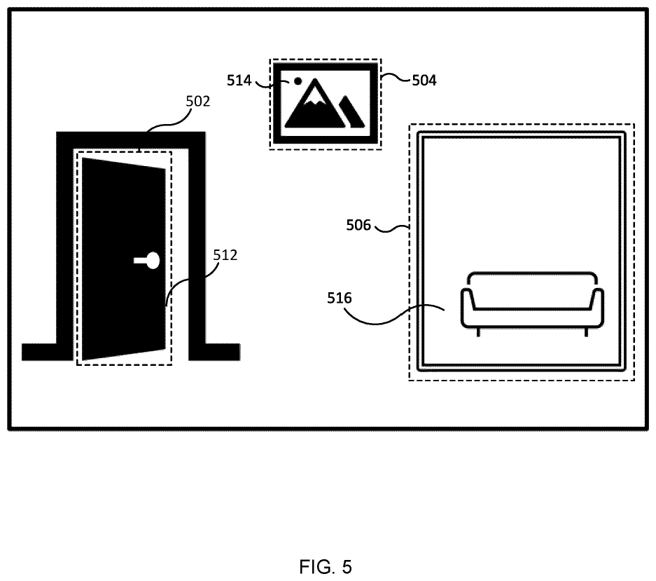

FIG. 5 shows three example contours 502-506 identified in the k-th image Iₖ. As shown in FIG. 5, the identified contours 502-506 may include an object (e.g., a painting 514) in the indoor environment, an opening (e.g., a door opening 512) to another space (e.g., a room), and a reflective surface (e.g., a mirror 516). Each of these contours is a candidate of a possible reflective surface (e.g., a mirror planar surface).

For each of the identified closed contours CLₖ (e.g., 502-506), two steps s312 and s314 are performed.

The step s312 comprises calculating the distance (d₂) between the scanning device 102 and the surface within the contour (which is a hypothetical mirror planar surface). The calculation of the distance may be based on the average depth of contour points (where each point may correspond to a group of pixels) that are located on the contour.

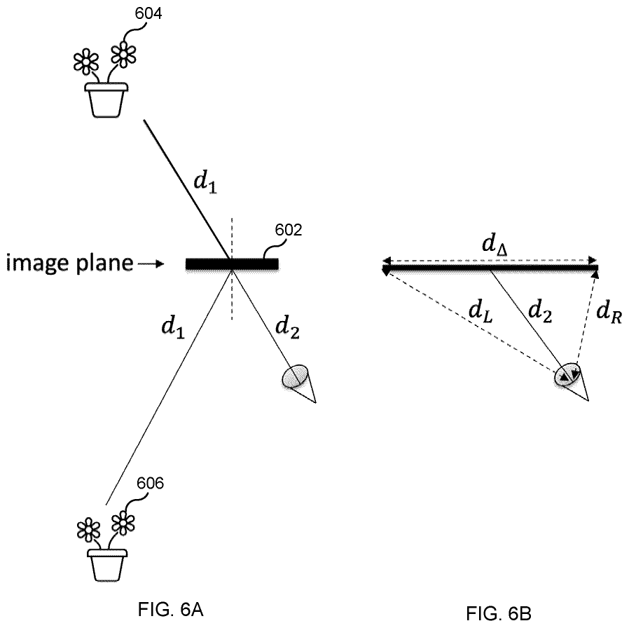

FIGS. 6A and 6B illustrate how the distance between the scanning device 102 and the planar surface 602 within the contour (i.e., the hypothetical mirror planar surface) is calculated. In the examples shown in FIG. 6A, the planar surface 602 within the contour is a reflective surface such as a mirror.

When facing the reflective surface 602 (e.g., a mirror), the scanning device 102 as well as our eyes “see” an image 604 of a real physical object 606 that is reflected by the mirror 602. As shown in FIG. 6A, the reflected image 604 is viewed as if it is placed behind the mirror plane. Thus, the depth distance of the reflected object 606 as measured by the scanning device 102 corresponds to the sum of (1) the distance (d₁) between the real physical object 606 and the mirror 602 and (2) the distance (d₂) between the mirror 602 and the scanning device 102. Therefore, the depth distance between the virtual object 604 and the scanning device 102 that is measured by the LiDAR sensor included in the scanning device 102 is d₁+d₂.

However, because d₂ cannot be measured directly by the LiDAR sensor, in one embodiment, it is estimated as the median of a triangle formed by a distance (d_{L}) between a left edge of the contour and the scanning device 102, a distance (d_{R}) between a right edge of the contour and the scanning device 102, and a distance between the left and right edges of the contour (d₄). Thus, the distance d₂ may be calculated as follows:

$${d}_{2} = \frac{1}{2} \sqrt{2 {d}_{L}^{2} + 2 {d}_{R}^{2} - {d}_{Δ}^{2}}$$

Referring back to FIG. 3, in step s314, key points are extracted from the image area confined by each of the identified contours. These key points are strictly located in the confined area and are typically located at the corners and/or the edges of object(s) captured in the images. There are various ways of extracting the key points. For example, one way of extracting the key points is using Speeded Up Robust Features (SURF) described in H. Bay, T. Tuytelaars and L. Van Gool, “SURF: Speeded Up Robust Features,” in Proc. European Conference on Computer Vision (ECCV), 2006, which is hereby incorporated by reference. Another way of extracting the key points is using Scale-Invariant Feature Transform (SIFT) described in D. Lowe, “Object recognition from local scale-invariant features.,” in Proc. International Conference on Computer Vision (ICCV), 1999, which is also incorporated by reference.

As a result of performing the steps s312 and s314, each of the identified contours (C) becomes associated with a) an estimated distance (d₂) between the scanning device and the planar surface of the contour and b) a set of key points (KP) extracted from the image area confined by the contour:

$$C \to ( {d}_{2} , KP ) .$$

Even though FIG. 3 shows that the step s314 is performed after the step s312 is performed, in other embodiments, the step s312 may be performed after the step s314 is performed.

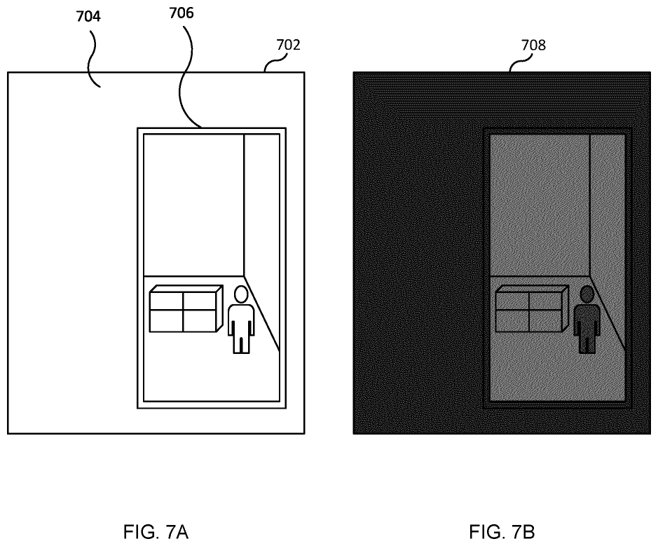

From among all identified contours obtained from the step s304, the contours that do not belong to a reflective surface are filtered out using depth information. More specifically, if a contour belongs to a reflective surface, due to a physical object's reflection included in the contour, the average depth variation of an area within the contour will be substantially greater than the average depth variation of other planar surface(s). This depth variation is shown in FIGS. 7A and 7B.

FIG. 7A shows an RGB image 702 captured using a camera and FIG. 7B shows a depth image 708 captured using a LiDAR sensor. As shown in FIG. 7A, the captured image 702 contains a first area 704 corresponding to a wall and a second area 706 corresponding to a mirror. In the physical world, a mirror has a flat surface. However, as shown in FIG. 7B, in the depth image 708, since the laser light emitted by the LiDAR sensor is reflected by the mirror surface 706, the mirror does not appear in the depth image 708. Instead, the depth value recorded by the LiDAR for the second area 706 corresponds to the total path of laser beams from an emitter (included in the scanning device) to the mirror surface and then from the mirror to the reflected physical object, as explained with respect to FIG. 6A.

Thus, in step s306, from among the identified contours, one or more contours for which the average depth of an area inside the contour is not significantly larger than the estimated depth of the image plane bounded by the contour are determined, and the determined contour(s) is filtered out from a candidate list of contours that are potential reflective surfaces, thereby reducing the contours included in the candidate list CL as follows:

$$if$$

$$\vert {d}_{KP} - {d}_{2} \vert > {σ}_{contour}^{2}$$

$$keep C as candidate mirror$$

$$else$$

$$remove C from the list$$

d_{KP} is an average of virtual depth distances between the scanning device 102 and the key points extracted from the area confined by the contour via the step s314. d_{KP} is referred as a virtual depth distance here because it is a distance between the scanning device 102 and the key points as virtually perceived by the scanning device 102, as illustrated in FIG. 6A.

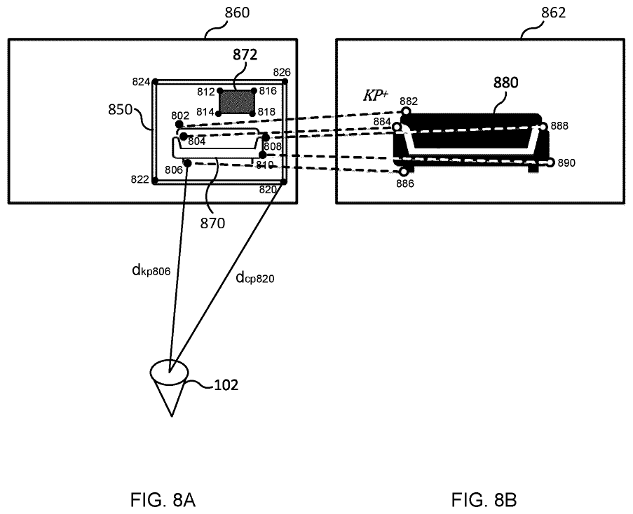

FIG. 8A shows a set of key points 802-818 included in the area confined by a contour 850. A depth distance of a key point is a distance between the key point and the scanning device 102. Thus, as an example, the depth distance dₖₚ₈₀₆ associated with the key point 806 is the distance between the key point 806 and the scanning device 102.

Then d_{KP} may be calculated as follows:

$${d}_{KP} = \frac{\begin{matrix}{d}_{kp 802} + {d}_{kp 804} + {d}_{kp 806} + {d}_{kp 808} + \\ {d}_{kp 810} + {d}_{kp 812} + {d}_{kp 814} + {d}_{kp 816} + {d}_{kp 818}\end{matrix}}{8}$$

As discussed above with respect to FIG. 6A, d₂ is a distance between the mirror plane and the scanning device 102 and σ_{contour}² is the variance of contour-point (“CP”) distances of individual contour points located on the contour. A contour-point distance is a distance between a contour point located on the contour and the scanning device 102. As an example, in FIG. 8A, the CP distance d_{cp820} of the contour point 820 is a distance between the contour point 820 and the scanning device 102. In FIG. 8A, four contour points 820-826 are defined on the contour 850. But the location and the number of the contour points in FIG. 8A are provided for illustration purpose only and do not limit the embodiments of this disclosure in any way.

Then σ_{contour}² may be calculated as follows:

$${σ}^{2} = \frac{{\sum }_{i = 1}^{M} ( {d}_{cdp - i} - μ )}{M} = \frac{( {d}_{cdp 820} - μ ) + ( {d}_{cdp 822} - μ ) + ( {d}_{cdp 824} - μ ) + ( {d}_{cdp 826} - μ )}{4}$$

where

$$μ = \frac{{d}_{cdp 820} + {d}_{cdp 822} + {d}_{cdp 824} + {d}_{cdp 826}}{4} .$$

As shown in FIG. 6A, if a contour (602) includes a mirror, the depth inside the mirror is significantly larger than the depth on the contour or surrounding walls, i.e., d_{KP}>>d₂. In such case the condition 1 above will be satisfied, and thus the contour will be kept as a candidate mirror in the candidate list. On the other than, if the depth inside the mirror is not significantly larger than the depth on the contour or surrounding walls, the condition 2 will be satisfied, and thus the contour will be removed from the candidate list of reflective surfaces.

In some scenarios, the step s306 may eliminate all contours identified in the step s302. In such scenarios, the process is terminated and it is concluded that there is no mirror in the captured scene. However, if the candidate list CL is not empty, step s308 is executed.

As discussed above, through the filtering of the step s306, the candidate list of contours (CL) that are potentially reflective surfaces is reduced. However, since the filtering of the step s306 cannot distinguish a passage to another space (e.g., a room) from a reflective surface, the candidate list generated through the step s306 may include contour(s) that belongs to a passage to another space.

More specifically, since the filtering of the step s306 is based on comparing (a) a difference between an average of the distances between the scanning device and the key points and a distance between the contour and the scanning device to (b) a variation of contour point distances between individual points on the contour and the scanning device, the comparison result for the contour belonging to a reflective surface and the comparison result for the contour belonging to a passage to another space are similar.

Therefore, in step s308, the contours included in the candidate list resulting from the step s306 are further analyzed to identify contour(s) that contains a reflective surface (e.g., a mirror) using image formation geometry and visual features.

As discussed above, when performing the scanning of the environment, the scanning is performed on the environment 360 degrees. Thus, in case one of the captured images includes a mirror showing a reflected scene, the captured real scene will appear in another of the captured images.

For example, FIGS. 8A and 8B show first and second images 860 and 862 that are captured by the scanning device 102. As shown in FIG. 8A, the first image 860 includes a contour 850 which is a mirror. The first image 860 also includes a reflected sofa image 870 which is a reflection of a real sofa that is reflected by the mirror and a shadow 872 of a physical object (not shown) formed by a ceiling light (not shown). The actual image 880 of the real sofa is included in the second image 862.

In step s308, a visual correspondence between the reflected object image 870 and the actual object image 880 is determined. To determine such visual correspondence, in some embodiments, searching for points that are matched to at least some of the key points 802-818 included in the contour 850 are performed on some of the captured images (e.g., 862).

For example, as shown in FIG. 8A, the first image 860 includes a group of key points 802-818 within the contour 850. In step s308, a search is performed on the images (e.g., 862) captured by the scanning device 102 to find matching key points 882-890 that are matched to at least some of the key points 802-818. There are different ways of finding the matching key points. For example, the key point matching may be performed with geometric verification and removing of outliers by RANSAC as described in M. A. Fischler and R. C. Bolles, “Random Sample Consensus: A Paradigm for Model Fitting with Applications to Image Analysis and Automated Cartography,” Association for Computing Machinery, vol. 24, pp. 381-395, 1981, which is herein incorporated by reference. Via the key point matching, the matching points 882-890 having the positional relationship that is same as the positional relationship of the key points 802-810 are identified.

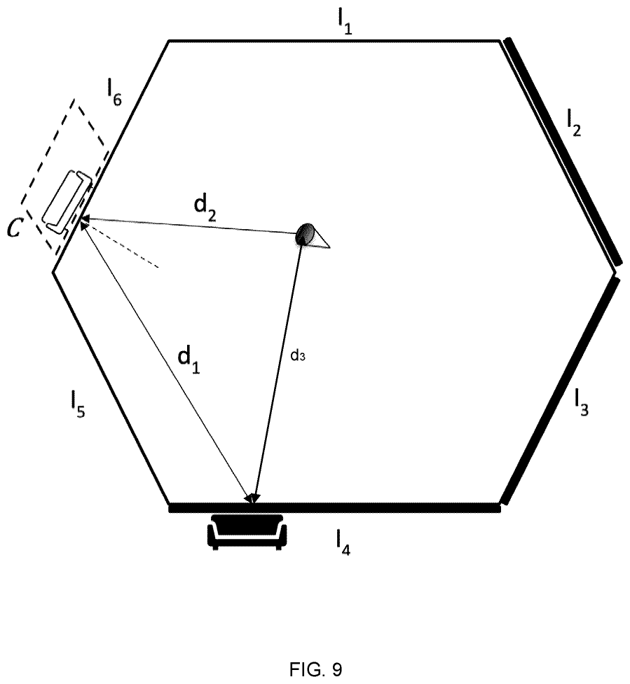

In finding the matching key points 882-890, there is no need to perform the search on all captured images. For example, as shown in FIG. 9, in searching for the matching key points, there is no need to perform the search on the images I₁ and I₆ because due to the positional relationships between the image I₆ and I₆ and between I₁ and I₆, it is unlikely that the sofa image is a reflection of an object included in the images I₁ and I₆. Thus, the search region for the matching key points may be limited to the images I₂, I₃, and I₄ which correspond to the sides of the environment that are opposite to the side of the image I₆.

Furthermore, searching for the matching key points may be performed on the flipped version of the captured images (e.g., I₂, I₃, and I₄).

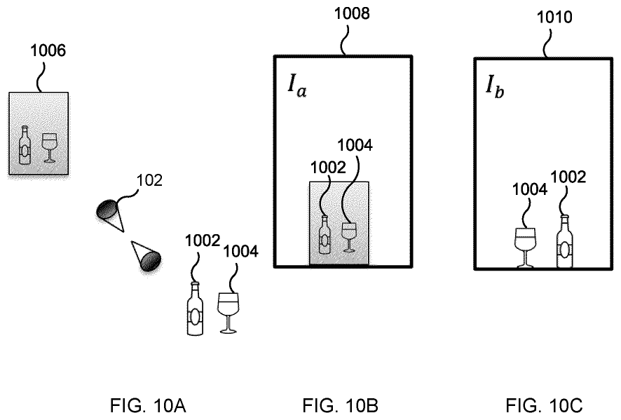

FIG. 10 provides an explanation as to why searching for the matching key points is performed on the flipped images. As shown in FIG. 10A, when objects (a bottle 1002 and a glass 1004) are reflected by a mirror 1006 and when the reflected image (a.k.a., a mirror image) is captured by the scanning device 102, in the captured mirror image 1008 shown in FIG. 10B, the objects are flipped—i.e., in the captured mirror image 1008, the bottle 1002 is on the left side of the glass 1004 even though in a direct captured image 1010 shown in FIG. 10C, the bottle 1002 is on the right side of the glass 1004. Therefore, the search for the matching key points included in the direct captured image 1010 is performed on the flipped version of the direct captured image 1010.

In some embodiments, instead of performing the search for the matching key points on the flipped image, Affine-Mirror Invariant Feature Transform (AMIFT) or MI-Scale-Invariant Feature Transform (MI-SIFT) may be used in the search process. The AMIFT is described in N. Mohtaram, A. Radgui, G. Caron and E. M. Mouaddib, “AMIFT: Affine mirror invariant feature transform,” in IEEE International Conference on Image Processing, ICIP, Athènes, Greece, 2018, which is hereby incorporated by reference. Also MI-SIFT is described in R. Ma, J. Chen and Z. Su, “MI-SIFT: Mirror and Inversion Invariant Generalization for SIFT Descriptor,” in Proceedings of the ACM International Conference on Image and Video Retrieval, 2010, which is hereby incorporated by reference.

Referring back to FIG. 8B, via the step s308, the matching key points 882-890 that are best matched to at least some of the key points 802-818 are identified from the captured image 862. Also, from among the key points 802-818, the key points 802-810 that are matched to the matching key points 882-890 are identified.

According to some embodiments, whether the contour under investigation includes a reflective surface (e.g., a mirror) is determined based on (1) the size of the area confining the matching key points 882-890, (2) the size of the area confining the key points 802-810 matched to the matching key points 882-890, and (3) the distances between the scanning device 102 and these points 802-810 and 882-890.

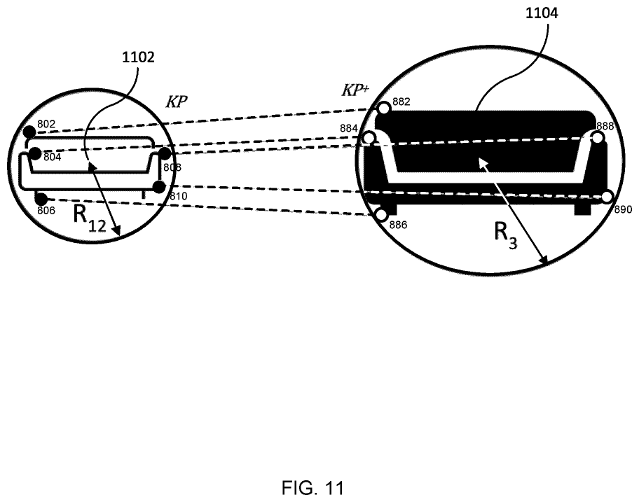

The size of the area confining the matching key points 882-890 and the size of the area confining the key points 802-810 can be determined as illustrated in FIG. 11.

First, in finding the size of the area confining the key points 802-810, a reference point of the key points 802-810 is determined. In some embodiments, the reference point is a center point 1102. After determining the center point 1102, a distance between the center point 1102 and each of the key points 802-810 is determined. Among the calculated distances, the largest distance is selected to be a radius (R₁₂) of the area confining the key points 802-810.

Similarly, in finding the size of the area confining the matching points 882-890, a reference point of the matching points 882-890 is determined. In some embodiments, the reference point is a center point 1104. After determining the center point 1104, a distance between the center point 1104 and each of the matching points 882-890 is determined. Among the calculated distances, the largest distance is selected to be a radius (R₃) of the area confining the matching points 882-890.

As discussed above, whether the contour includes a reflective surface is determined not only based on the size of the area confining the points, but also based on a distance (d₃) between the scanning device 102 and the matching points 882-890 (which is shown in FIG. 9) and a virtual depth distance (a.k.a., depth distance) (d₁₂) between the scanning device 102 and the key points 802-810 (which is shown in FIG. 6A). d₁₂ is referred as a virtual depth distance here because it is a distance between the scanning device 102 and the key points 802-810 as virtually perceived by the scanning device 102, as illustrated in FIG. 6A.

In some embodiments, d₃ is an average of a sum of each distance between the scanning device 102 and each matching key point included in the key points 802-810. Similarly, in some embodiments, d₁₂ is an average of a sum of each distance between the scanning device and each key point included in the key points 802-810.

If the contour under investigation contains a reflective surface, the following proportional relationship is observed:

$$\frac{{d}_{1} + {d}_{2}}{{d}_{3}} ∝ \frac{{R}_{3}}{{R}_{12}}$$

The proportional relationship exists because the increase of the distance between the object and the camera capturing the object is inversely proportional to the object's observable size (e.g., as the camera becomes further away from the object, the object will appear smaller in the images captured by the camera). Here, the size means a linear size. The area covered by the object naturally changes as square of its linear size.

Because it is likely that the object associated with the key points 802-810 and the object associated with the matching key points 882-890 are the same object, a ratio of their sizes corresponds to a ratio of their distances with respect to the camera.

Therefore, in some embodiments, the contour C is determined to include a reflective surface as follows:

$$if$$

$$\frac{{d}_{1} + {d}_{2}}{{d}_{3}} ∈ [ ( 1 - β ) \frac{{R}_{3}}{{R}_{12}} , ( 1 + β ) \frac{{R}_{3}}{{R}_{12}} ]$$

$$declare C a mirror$$

$$else$$

$$remove C from the list$$

with β=0.05 accounting for measurement noise, which can cause deviation of the measured ratios.

Referring back to FIG. 3, after performing the step s310, in step s312, the remaining contours included in the candidate list (after going through the filtering steps s306 and s310) are classified as containing a reflective surface and the image areas confined by the contours are removed from the 3D reconstruction of the environment or replaced with a planar surface.

More specifically, if a contour Cₘᵢᵣᵣₒᵣ is classified as containing a reflective surface, in case multiple 360° image scans are performed in the current physical environment, the location of the contour Cₘᵢᵣᵣₒᵣ is propagated to all other image scans to compensate for possible failure of detecting reflective surfaces in those images. The failure occurs typically when the laser beam from the LiDAR sensor reaches the reflective surface area at a large incident angle. In such case some of the reflective surface area may not return any light back to the LiDAR sensor.

As discussed above, if an area in a captured RGB-D image of an environment is classified as containing a mirror, the area can be removed from the 3D reconstruction of the environment or can be replaced with a planar surface for the 3D reconstruction of the environment.

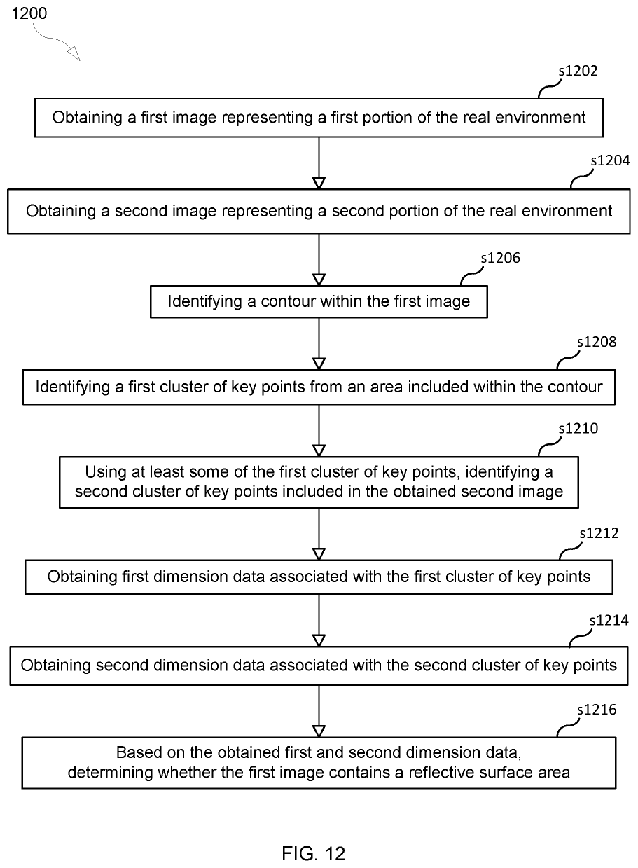

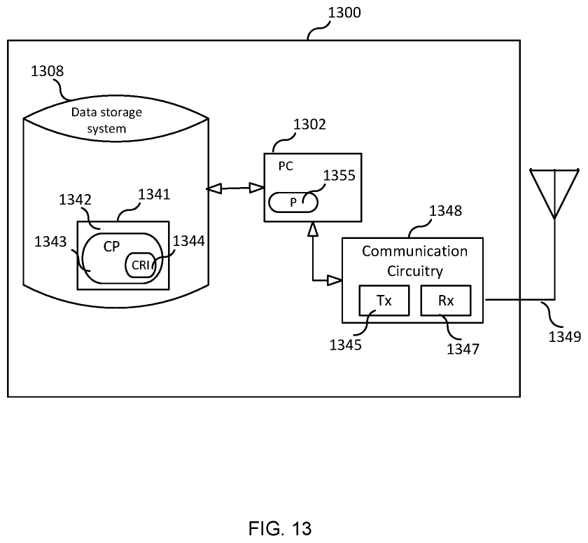

FIG. 12 shows a process 1200 for generating a three-dimensional (3D) representation of a real environment according to some embodiments. The process 1200 may be performed by an apparatus (e.g., the apparatus shown in FIG. 13). The process may begin with step s1202. Step s1202 comprises obtaining a first image representing a first portion of the real environment. Step s1204 comprises obtaining a second image representing a second portion of the real environment. Step s1206 comprises identifying a contour within the first image. Step s1208 comprises identifying a first cluster of key points from an area included within the contour. Step s1210 comprises using at least some of the first cluster of key points, identifying a second cluster of key points included in the obtained second image. Step 1212 comprises obtaining first dimension data associated with the first cluster of key points. Step 1214 comprises obtaining second dimension data associated with the second cluster of key points. Step 1216 comprises, based on the obtained first and second dimension data, determining whether the first image contains a reflective surface area.

In some embodiments, the method further comprises flipping the obtained second image and identifying within the flipped second image the second cluster of key points that are matched to said at least some of the first cluster of key points.

In some embodiments, positional relationship of the second cluster of key points are matched to positional relationship of said at least some of the first cluster of key points.

In some embodiments, the method further comprises obtaining a depth distance (d₁₂) between said at least some of the first cluster of key points and a camera capturing the first and second images, wherein the first dimension data includes the depth distance (d₁₂) between said at least some of the first cluster of key points and the camera.

In some embodiments, the method further comprises obtaining a distance (d₃) between the second cluster of key points and a camera capturing the first and second images, wherein the second dimension data includes the distance (d₃) between the second cluster of key points and the camera.

In some embodiments, the method further comprises determining a first reference point based on said at least some of the first cluster of key points, determining a first dimension value (R₁₂) corresponding to a distance between the first reference point and a key point included in said at least some of the first cluster of key points, determining a second reference point based on the second cluster of key points, and determining a second dimension value (R₃) corresponding to a distance between the second reference point and a key point included in the second cluster of key points, wherein the first dimension data includes the first dimension value (R₁₂), and the second dimension data includes the second dimension value (R₃).

In some embodiments, the method further comprises determining whether a first ratio of the depth distance (d₁₂) between said at least some of the first cluster of key points and the camera to the distance (d₃) between the second cluster of key points and the camera is within a range, and based at least on determining that the first ratio is within the range, determining that the first image contains a reflective surface area.

In some embodiments, the first ratio is determined based on the depth distance (d₁₂) between said at least some of the first cluster of key points and the camera divided by the distance (d₃) between the second cluster of key points and the camera.

In some embodiments, the range is defined based on a second ratio of the first dimension value (R₁₂) and the second dimension value (R₃).

In some embodiments, determining whether the first ratio is within the range comprises determining whether

$$\frac{{d}_{12}}{{d}_{3}}$$

is between

$$( 1 - β ) \frac{{R}_{3}}{{R}_{12}}$$

$$and$$

$$( 1 + β ) \frac{{R}_{3}}{{R}_{12}} ,$$

where β is a predefined rational number.

In some embodiments, the method further comprises obtaining a depth distance (dₖₚ) between the first cluster of key points and a camera capturing the first and second images, wherein the first dimension data includes the depth distance (dₖₚ) between the first cluster of key points and the camera.

In some embodiments, obtaining the depth distance (dₖₚ) between the first cluster of key points and the camera comprises: determining an individual key point distance between each key point included in the first cluster of key points and the camera; and calculating an average of the determined individual key point distances, wherein the depth distance (dₖₚ) between the first cluster of key points and the camera is determined based on the calculated average.

In some embodiments, the method further comprises obtaining a distance (d₂) between the contour and the camera, comparing the distance (d₂) between the contour and the camera to the depth distance (dₖₚ) between the first cluster of key points and the camera, and based on the comparison, determining whether the first image does not contain a reflective surface.

In some embodiments, the method further comprises determining a left distance (d_{L}) between a left boundary of the contour and the camera, determining a right distance (d_{R}) between a right boundary of the contour and the camera, determining a gap distance (d_{Δ}) between the left boundary and the right boundary, wherein the distance (d₂) between the contour and the camera is calculated using the left distance, the right distance, and the gap distance.

In some embodiments, the distance (d₂) between the contour and the camera is calculated as follows:

$${d}_{2} = \frac{1}{2} \sqrt{2 {d}_{L}^{2} + 2 {d}_{R}^{2} - {d}_{Δ}^{2}} ,$$

where
d_{L} is the left distance (d_{L}), d_{R} is the right distance (d_{R}), and d_{Δ} is the gap distance.

In some embodiments, the contour includes a plurality of individual points disposed on the contour, and the method comprises: determining an individual contour point distance between each of the plurality of individual points on the contour and the camera, calculating a variation value (σ_{contour}) indicating a variation among the determined individual contour point distances, and determining whether the first image does not contain a reflective surface based on the variation value (σ_{contour}).

In some embodiments, determining whether the first image does not contain a reflective surface comprises determining whether |dₖₚ−d₂|>σ_{contour}², where dₖₚ is the depth distance between the first cluster of key points and the camera, d₂ is the distance between the contour and the camera, and σ_{contour} is the variation value.

In some embodiments, as a result of determining that |dₖₚ−d₂|≤σ_{contour}², determining that the first image does not contain a reflective surface area.

In some embodiments, the method further comprises determining that the first image contains a reflective surface area, as a result of determining that the first image contains a reflective surface area, determining a location of the reflective surface area within the first image, obtaining a third image representing at least a part of the first portion of the real environment, identifying a portion of the third image corresponding to the location of the reflective surface area within the first image, and removing the identified portion from the third image or replacing the identified portion with a different image.

FIG. 13 is a block diagram of an entity 1300 that is capable of performing the method (e.g., the method shown in FIG. 12) described above, according to some embodiments. In some embodiments, the entity 1300 may be the scanning device 102. But in other embodiments, the entity 1300 may be a separate entity that is different from the scanning device 102. As shown in FIG. 13, the entity 1300 may comprise: processing circuitry (PC) 1302, which may include one or more processors (P) 1355 (e.g., one or more general purpose microprocessors and/or one or more other processors, such as an application specific integrated circuit (ASIC), field-programmable gate arrays (FPGAs), and the like); communication circuitry 1348, which is coupled to an antenna arrangement 1349 comprising one or more antennas and which comprises a transmitter (Tx) 1345 and a receiver (Rx) 1347 for enabling the entity 102 to transmit data and receive data (e.g., wirelessly transmit/receive data); and a local storage unit (a.k.a., “data storage system”) 1308, which may include one or more non-volatile storage devices and/or one or more volatile storage devices. In embodiments where PC 1302 includes a programmable processor, a computer program product (CPP) 1341 may be provided. CPP 1341 includes a computer readable medium (CRM) 1342 storing a computer program (CP) 1343 comprising computer readable instructions (CRI) 1344. CRM 1342 may be a non-transitory computer readable medium, such as, magnetic media (e.g., a hard disk), optical media, memory devices (e.g., random access memory, flash memory), and the like. In some embodiments, the CRI 1344 of computer program 1343 is configured such that when executed by PC 1302, the CRI causes the entity 102 to perform steps described herein (e.g., steps described herein with reference to the flow charts). In other embodiments, the entity 102 may be configured to perform steps described herein without the need for code. That is, for example, PC 1302 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for generating a three-dimensional (3D) representation of a real environment, the method being performed by an apparatus, the method comprising:
obtaining a first image representing a first portion of the real environment;
obtaining a second image representing a second portion of the real environment;
identifying a contour within the first image;
identifying a first cluster of key points from an area included within the contour;
using at least some of the first cluster of key points, identifying a second cluster of key points included in the obtained second image;
obtaining first dimension data associated with the first cluster of key points;
obtaining second dimension data associated with the second cluster of key points; and
based on the obtained first and second dimension data, determining whether the first image contains a reflective surface area.

2. The method of claim 1, comprising:
flipping the obtained second image; and
identifying within the flipped second image the second cluster of key points that are matched to said at least some of the first cluster of key points, wherein
positional relationship of the second cluster of key points are matched to positional relationship of said at least some of the first cluster of key points.

3. (canceled)

4. The method of claim 1, comprising:
obtaining a depth distance (d₁₂) between said at least some of the first cluster of key points and a camera capturing the first and second images, wherein
the first dimension data includes the depth distance (d₁₂) between said at least some of the first cluster of key points and the camera.

5. The method of claim 1, comprising:
obtaining a distance (d₃) between the second cluster of key points and a camera capturing the first and second images, wherein
the second dimension data includes the distance (d₃) between the second cluster of key points and the camera.

6. The method of claim 1, comprising:
determining a first reference point based on said at least some of the first cluster of key points;
determining a first dimension value (R₁₂) corresponding to a distance between the first reference point and a key point included in said at least some of the first cluster of key points;
determining a second reference point based on the second cluster of key points; and
determining a second dimension value (R₃) corresponding to a distance between the second reference point and a key point included in the second cluster of key points, wherein
the first dimension data includes the first dimension value (R₁₂), and
the second dimension data includes the second dimension value (R₃).

7. The method of claim 5, comprising:
determining whether a first ratio of the depth distance (d₁₂) between said at least some of the first cluster of key points and the camera to the distance (d₃) between the second cluster of key points and the camera is within a range; and
based at least on determining that the first ratio is within the range, determining that the first image contains a reflective surface area.

8. The method of claim 7, wherein the first ratio is determined based on the depth distance (d₁₂) between said at least some of the first cluster of key points and the camera divided by the distance (d₃) between the second cluster of key points and the camera.

9. The method of claim 7, wherein the range is defined based on a second ratio of the first dimension value (R₁₂) and the second dimension value (R₃).

10. The method of claim 7, wherein determining whether the first ratio is within the range comprises determining whether
$$\frac{{d}_{12}}{{d}_{3}}$$
is between
$$( 1 - β ) \frac{{R}_{3}}{{R}_{12}}$$
$$and$$
$$( 1 + β ) \frac{{R}_{3}}{{R}_{12}} ,$$
where β is a predefined rational number.

11. The method of claim 1, further comprising:
obtaining a depth distance (dₖₚ) between the first cluster of key points and a camera capturing the first and second images, wherein the first dimension data includes the depth distance (dₖₚ) between the first cluster of key points and the camera.

12. The method of claim 11, wherein obtaining the depth distance (dₖₚ) between the first cluster of key points and the camera comprises:
determining an individual key point distance between each key point included in the first cluster of key points and the camera; and
calculating an average of the determined individual key point distances, wherein
the depth distance (dₖₚ) between the first cluster of key points and the camera is determined based on the calculated average.

13. The method of claim 11, comprising:
obtaining a distance (d₂) between the contour and the camera;
comparing the distance (d₂) between the contour and the camera to the depth distance (dₖₚ) between the first cluster of key points and the camera; and
based on the comparison, determining whether the first image does not contain a reflective surface.

14. The method of claim 13, comprising:
determining a left distance (d_{L}) between a left boundary of the contour and the camera;
determining a right distance (d_{R}) between a right boundary of the contour and the camera;
determining a gap distance (d_{Δ}) between the left boundary and the right boundary, wherein
the distance (d₂) between the contour and the camera is calculated using the left distance, the right distance, and the gap distance.

15. The method of claim 14, wherein the distance (d₂) between the contour and the camera is calculated as follows:
$${d}_{2} = \frac{1}{2} \sqrt{2 {d}_{L}^{2} + 2 {d}_{R}^{2} - {d}_{Δ}^{2}} ,$$
where
d_{L} is the left distance (d_{L}), d_{R} is the right distance (d_{R}), and d_{Δ} is the gap distance.

16. The method of claim 1, wherein
the contour includes a plurality of individual points disposed on the contour, and
the method comprises:
determining an individual contour point distance between each of the plurality of individual points on the contour and the camera;
calculating a variation value (σ_{contour}) indicating a variation among the determined individual contour point distances; and
determining whether the first image does not contain a reflective surface based on the variation value (σ_{contour}).

17. The method of claim 16, wherein determining whether the first image does not contain a reflective surface comprises:
determining whether |dₖₚ−d₂|>σ_{contour}², where dₖₚ is the depth distance between the first cluster of key points and the camera, d₂ is the distance between the contour and the camera, and σ_{contour} is the variation value.

18. The method of claim 17, wherein as a result of determining that |dₖₚ−d₂|>σ_{contour}², determining that the first image does not contain a reflective surface area.

19. The method of claim 1, further comprising:
determining that the first image contains a reflective surface area;
as a result of determining that the first image contains a reflective surface area, determining a location of the reflective surface area within the first image;
obtaining a third image representing at least a part of the first portion of the real environment;
identifying a portion of the third image corresponding to the location of the reflective surface area within the first image; and
removing the identified portion from the third image or replacing the identified portion with a different image.

20-21. (canceled)

22. An apparatus for generating a three-dimensional (3D) representation of a real environment, the apparatus comprising:
a memory; and
processing circuitry coupled to the memory, wherein the apparatus is configured to:
obtain a first image representing a first portion of the real environment;
obtain a second image representing a second portion of the real environment;
identify a contour within the first image;
identify a first cluster of key points from an area included within the contour;
using at least some of the first cluster of key points, identify a second cluster of key points included in the obtained second image;
obtain first dimension data associated with the first cluster of key points;
obtain second dimension data associated with the second cluster of key points; and
based on the obtained first and second dimension data, determine whether the first image contains a reflective surface area.

23-40. (canceled)

41. A computer program product comprising a non-transitory computer readable medium storing instructions which when executed by processing circuitry of a system causes the system to perform a process for generating a three-dimensional (3D) representation of a real environment, which comprises:
obtaining a first image representing a first portion of the real environment;
obtaining a second image representing a second portion of the real environment;
identifying a contour within the first image;
identifying a first cluster of key points from an area included within the contour;
using at least some of the first cluster of key points, identifying a second cluster of key points included in the obtained second image;
obtaining first dimension data associated with the first cluster of key points;
obtaining second dimension data associated with the second cluster of key points; and
based on the obtained first and second dimension data, determining whether the first image contains a reflective surface area.
